(19) United States
(12) Patent Application Publication
(10) Pub. No.: US 2009/0251730 A1
(43) Pub. Date: Oct. 8, 2009

(54) DISTRIBUTION APPARATUS, DISTRIBUTION METHOD, AND COMPUTER-READABLE STORAGE MRDIUM

(75) Inventor: Kotaro Yamaguchi, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/420,646

(22) Filed: Apr. 8, 2009

(30) Foreign Application Priority Data
Apr. 8, 2008 (JP) 2008-100678

(51) Int. Cl. G06F 3/12

(52) U.S. Cl. 358/1.15

(57) ABSTRACT

A distribution apparatus includes a storing unit configured to store in a storage medium information about firmware used in an image forming apparatus associated with information about a printer driver that corresponds to the firmware, an acquisition unit configured to acquire information about a printer driver in a terminal apparatus, a first distribution unit configured to distribute a printer driver corresponding to firmware which a user instructs to distribute, based on the information acquired by the acquisition unit and the information stored by the storing unit, and a second distribution unit configured to distribute the firmware which the user instructs to distribute.

### BACKGROUND OF THE INVENTION

1. Field of the Invention

The present invention relates to a distribution apparatus, distribution method, and computer-readable storage medium. In particular, the present invention is suitable for updating firmware in an image forming apparatus.

2. Description of the Related Art

Conventionally, there is a system which remotely updates firmware (software for performing basic control of hardware in an image forming apparatus) in an image forming apparatus such as a copying machine or a printer connected to a local area network (LAN). In such a system, a plurality of image forming apparatuses and a distribution host that instructs the plurality of image forming apparatuses to update the firmware communicate with each other via the LAN, wide area network (WAN), or the Internet. The distribution host then distributes the firmware to the image forming apparatus by an instruction from an operator of the distribution host, and the firmware in the image forming apparatus is thus updated. The firmware is updated to solve an operation problem originating in the firmware, update a function, and the like.

Further, a computer (hereinafter referred to as a client personal computer (PC)) connected to the LAN often uses the image forming apparatus as a network printer. In such a case, it is necessary to preinstall dedicated software for issuing a print command to the image forming apparatus (hereinafter referred to as a printer driver) in the client PC.

When the firmware in the image forming apparatus is to be updated in the above-described system, the printer driver in the client PC may also be required to be updated along with the firmware. For example, print commands that can be interpreted by the image forming apparatus or parameter settings may change by updating the firmware. As a result, the image forming apparatus may not be able to correctly interpret print commands and parameters issued by the current printer driver.

To solve such a problem, there are methods for easily updating the printer driver in the client PC. For example, the printer driver is located in a printer, and the printer driver is transmitted to the client PC according to a request from the client PC or a user instruction from a printer operation unit (refer to Japanese Patent Application Laid-Open No. 2001-296979).

Further, United States Publication No. 2003/0200289 discusses a method in which information about client PCs are displayed as a list on a server side, and a printer driver is transmitted from the server to the client PC and installed in the client PC, based on a user operation on the displayed list. The United States Publication No. 2003/0200289 further discusses the server executing an information gathering program on the client PC side and collecting information about the client PCs including printer settings.

### SUMMARY OF THE INVENTION

According an aspect of the present invention, a distribution apparatus includes a storing unit configured to store in a storage medium information about firmware used in an image forming apparatus associated with information about a printer driver that corresponds to the firmware, an acquisition unit configured to acquire information about a printer driver in a terminal apparatus, a first distribution unit configured to distribute a printer driver that corresponds to firmware which a user instructs to distribute, based on the information acquired by the acquisition unit and the information stored by the storing unit, and a second distribution unit configured to distribute the firmware which the user instructs to distribute.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of an overall configuration of a printing system according to an exemplary embodiment of the present invention.

FIG. 2 is a block diagram illustrating an example of a controller which performs control of the entire image forming apparatus according to the exemplary embodiment of the present invention.

FIG. 3 is a block diagram illustrating an example of a hardware configuration of a distribution host according to the exemplary embodiment of the present invention.

FIG. 4 illustrates an example of a printer setting notification sequence transmitted from a client PC to the image forming apparatus according to the exemplary embodiment of the present invention.

FIG. 5 illustrates an example of sequences of firmware distribution and printer driver distribution from the transmission host to the image forming apparatus, and of printer driver distribution from the image forming apparatus to the client PC according to the exemplary embodiment of the present invention.

FIG. 6 illustrates an example of a firmware distribution instruction screen displayed on a display device of the distribution host according to the exemplary embodiment of the present invention.

FIG. 7 illustrates an example of a firmware distribution instruction details screen displayed on a display device of the distribution host according to the exemplary embodiment of the present invention.

FIG. 8 is a schematic diagram illustrating an example of a content of an access client list managed in the image forming apparatus according to the exemplary embodiment of the present invention.

FIG. 9 is a schematic diagram illustrating an example of a content of a corresponding driver list managed in the distribution host according to the exemplary embodiment of the present invention.

FIG. 10 is a flowchart illustrating an example of a distribution printer driver selection process (corresponding to step S503 to step S505, and step S512 to step S514 illustrated in FIG. 5) performed by the distribution host according to the exemplary embodiment of the present invention.

FIG. 11 is a flowchart illustrating an example of a process for selecting a printer driver distribution destination client PC (corresponding to step S506, step S507, step S515, and step S516 illustrated in FIG. 5) performed by the image forming apparatus according to the exemplary embodiment of the present invention.

### DETAILED DESCRIPTION OF THE EMBODIMENTS

Various exemplary embodiments, features, and aspects of the invention will be described in detail below with reference to the drawings.

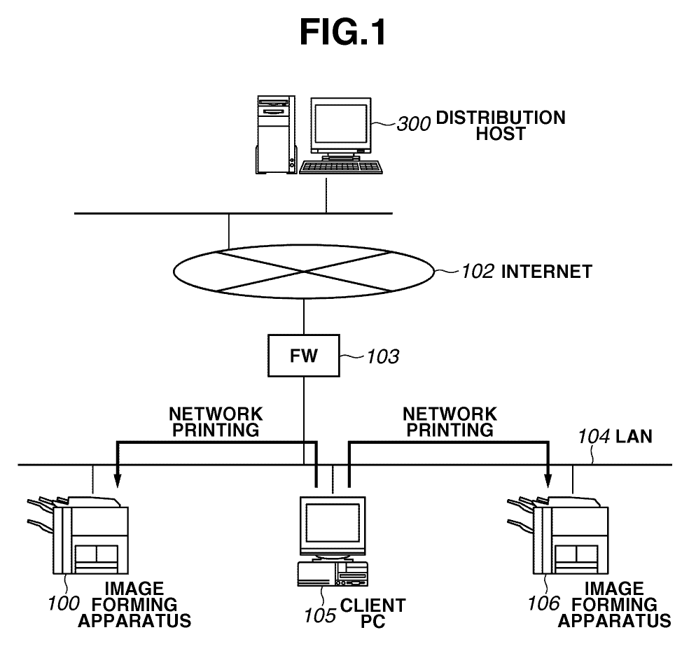

FIG. 1 illustrates an example of an overall configuration of a printing system according to an exemplary embodiment of the present invention.

Referring to FIG. 1, a distribution host 300 (server) is a computer which distributes firmware or printer drivers to image forming apparatuses 100 and 106. The distribution host 300 and image forming apparatuses 100 and 106 communicate with each other via the Internet 102 and a LAN 104.

The LAN 104 is an example of a user side network. The image forming apparatuses 100 and 106 and a client PC 105 are connected to each other via the LAN 104. Further, a firewall 103 is installed between the Internet 102 and the LAN 104.

The image forming apparatuses 100 and 106 regularly communicate with the distribution host 300 via the Internet 102 and the LAN 104, and inquires the distribution host 300 whether there is a firmware distribution instruction. For example, a Simple Object Access Protocol (SOAP) is used in such communication.

The client PC 105 is an example of a terminal apparatus, and uses the image forming apparatuses 100 and 106 as network printers via the LAN 104. Examples of the image forming apparatuses 100 and 106 are a digital multifunction image forming apparatus including a print function, a facsimile function, and a copy function, and a printer.

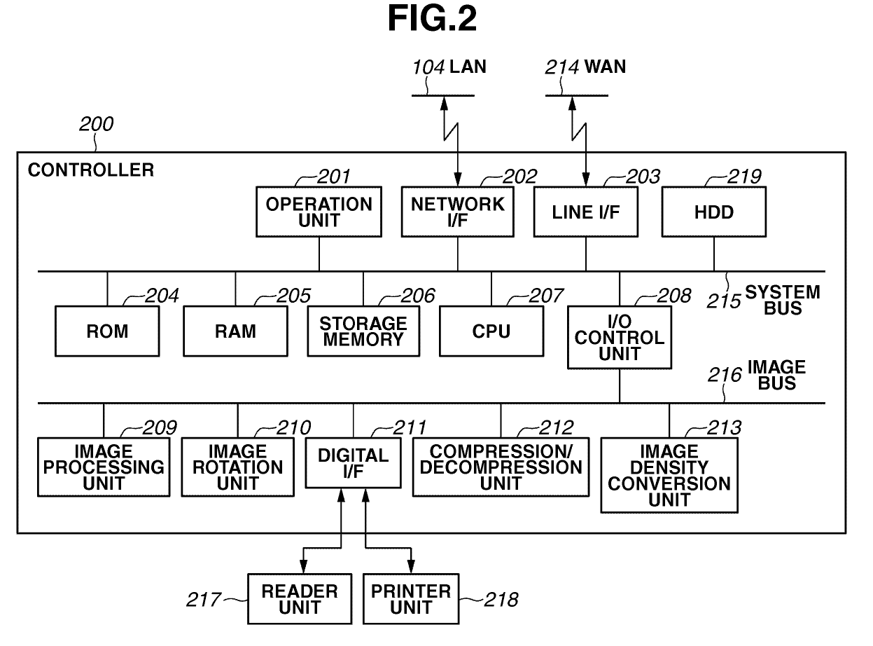

FIG. 2 is a block diagram illustrating an example of a configuration of a controller 200 which performs overall control of the image forming apparatus 100 or 106.

Referring to FIG. 2, each component of the controller 200 is connected to at least one of a system bus 215 and an image bus 216. A read-only memory (ROM) 204 stores a control program of the image forming apparatus 100 or 106. A central processing unit (CPU) 207 executes the control program. A random access memory (RAM) 205 is a work memory area for executing programs. Further, the RAM 205 is an image memory which temporarily stores image data.

A storage memory 206 is a non-volatile memory which stores information necessary to be stored after the image forming apparatus 100 or 106 is reactivated. Such information include settings of various operation modes, address list, counter value, failure information such as error, jam, and alarm, device identification (ID) for identifying each of the image forming apparatuses 100 and 106, and product names. A hard disk drive (HDD) 219 stores (a great amount of) image data handled by the image forming apparatuses 100 and 106, and the control program of the image forming apparatus 100 or 106.

A network interface (I/F) 202 is an interface for connecting to the LAN 104, and used in communicating with external devices such as the distribution host 300 via the LAN 104. A line I/F 203 is connected to an integrated services digital network (ISDN) or a public telephone line (WAN 214 in FIG. 2). The line I/F 203 is controlled by a communication control program stored in the ROM 204, and transmits and receives data to and from remote terminals via a network control unit (NCU). Facsimile data is also transmitted and received using the line I/F 203.

An operation unit 201 includes a display unit and a key input unit which are controlled by the CPU 207. An operator such as a user specifies various setting regarding scan-reading and printing, or instructs to start or end a process via the key input unit.

An input/output (I/O) control unit 208 is a bus bridge for connecting the system bus 215 and the image bus 216 that transfers image data at high speed.

The above-described components are connected to the system bus 215.

In addition to the I/O control unit 208, the components described below are connected to the image bus 216. A digital I/F 211 connects a reader unit 217 and a printer unit 218 of the image forming apparatus 100 or 106 to the controller 200 and performs synchronous/asynchronous conversion of image data. Further, information detected by various sensors located inside the reader unit 217 and the printer unit 218 is output to the system bus 215 via the digital I/F 211 and the I/O control unit 208.

An image processing unit 209 corrects, processes, and edits input image data and output image data. An image rotation unit 210 rotates image data. An image compression/decompression unit 212 compresses and decompresses multi-valued image data using Joint Photographic Experts Group (JPEG) compression and decompression, and compresses and decompresses binary image data using Joint Bi-level Image Experts Group (JBIG), Modified Modified READ (relative element address designate) (MMR), modified READ (MR), or modified Huffman (MH) compression and decompression. An image density conversion unit 213 converts a resolution of the output image data.

The CPU 207 executes a control program (hereinafter referred to as firmware) to instruct the network I/F 202 to regularly communicate with the distribution host 300. The network I/F 202 communicates with the distribution host 300 to notify version information of firmware in the image forming apparatus and to inquire about firmware distribution.

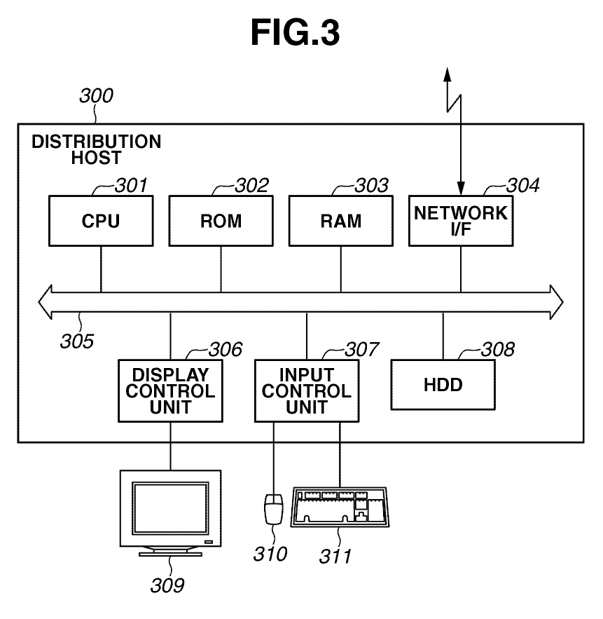

FIG. 3 is a block diagram illustrating a hardware configuration of the distribution host 300. Since the client PC 105 is also realized by similar hardware as the distribution host 300, the hardware configuration of the distribution host 300 will be described below, and a description of the hardware configuration of the client PC 105 will be omitted.

Referring to FIG. 3, a CPU 301 which controls the distribution host 300, and a ROM 302 which stores a boot program necessary for activating the system are connected to a system bus 305. Further, a RAM 303 which is a work memory necessary when the CPU 301 executes a program, and a network I/F 304 used in communicating with an external device via the Internet 102 and the LAN 104 are connected to the system bus 305. Additionally, a display control unit 306, an input control unit 307, and an HDD 308 storing programs to be executed by the CPU 301 are connected to the system bus 305. Further, a display device 309 is connected to the display control unit 306, and input devices 310 and 311 are connected to the input control unit 307.

Further, a printer driver is preinstalled in the HDD 308 of the client PC 105. Printer driver settings are specified by a user operation, so that the image forming apparatuses 100 and 106 can be used as a network printer. Such printer driver settings include network addresses and port numbers of the image forming apparatuses 100 and 106, and designation of a printer driver to be used.

The display control unit 306 of the distribution host 300 displays a firmware distribution instruction screen on the display device 309. An operator of the distribution host 300 uses the input devices 310 and 311 to instruct the distribution host 300 to distribute firmware to the desired image forming apparatus 100 or 106.

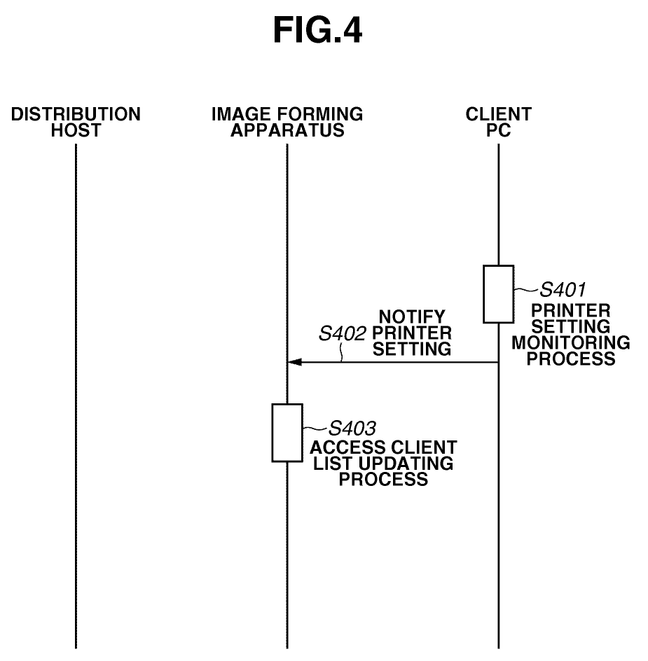

FIG. 4 illustrates an example of a printer setting notification sequence, from the client PC 105 to the image forming apparatus 100 or 106.

Referring to FIG. 4, the process is performed downwards from the top of the page. The CPU 301 in the client PC 105 continuously executes a printer setting monitoring program that collects the printer settings of the client PC 105 and notifies the image forming apparatus 100 or 106 of the printer settings. More specifically, the printer settings include, for example, a hardware ID for uniquely identifying the client PC 105, an IP address of the client PC 105, and a type of an operating system (OS) installed in the client PC 105. Further, the printer settings include a type of Page Description Language (PDL) of the printer driver used in the client PC 105, and a version of the printer driver. In addition, the printer settings can include a media access control (MAC) address and a printer port setting.

In step S401, the client PC 105 starts performing a printer setting monitoring process by running the printer setting monitoring program, when the above-described printer settings are newly specified or changed.

In step S402, the client PC 105 notifies the printer settings to the image forming apparatus 100 or 106 to be used (controlled) as the network printer. For example, if printer driver settings to the image forming apparatus 100 is newly specified or changed, the client PC 105 notifies the image forming apparatus 100 of the printer settings. On the other hand, if printer driver settings to the image forming apparatus 106 is newly specified or changed, the client PC 105 notifies the image forming apparatus 106 of the printer settings.

The CPU 207 in the image forming apparatus 100 or 106 constantly activates the firmware, so that the image forming apparatus 100 or 106 is operating to receive printer setting notifications from the client PC 105. The image forming apparatuses 100 and 106 manage an access client list 800 to be described below in the HDD 219. In step S403, the image forming apparatus 100 or 106 performs an access client list updating process to update the access client list 800 using a content of the received printer settings.

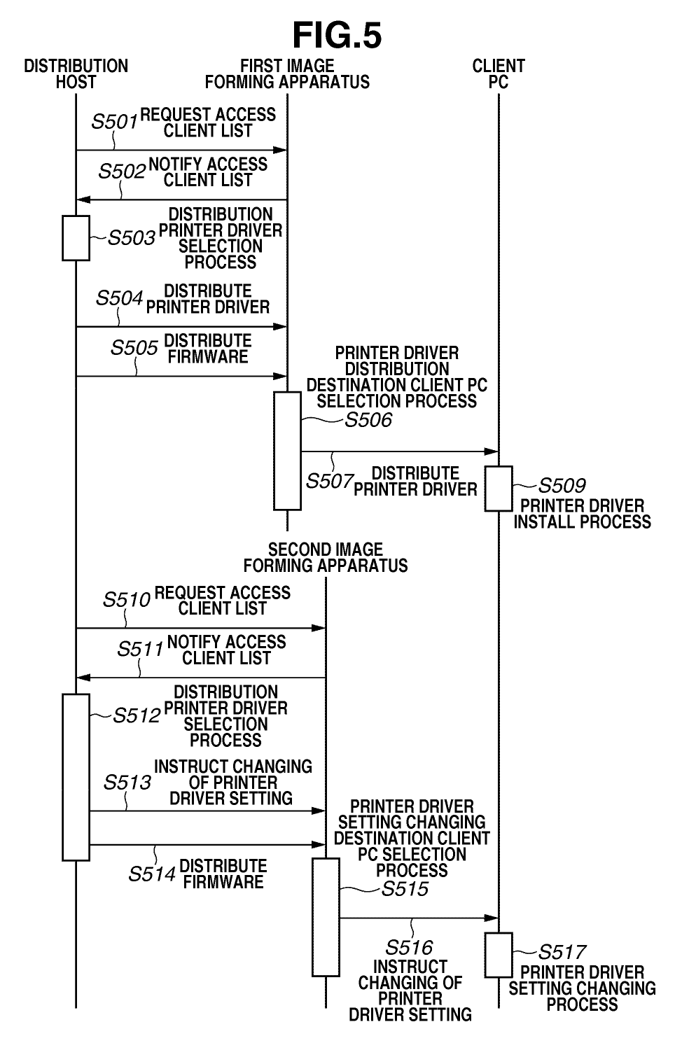

FIG. 5 illustrates an example of sequences of distributing firmware and printer driver from the distribution host 300 to the image forming apparatus 100 or 106, and of distributing a printer driver from the image forming apparatuses 100 or 106 to the client PC 105. In particular, FIG. 5 illustrates an example of a sequence when the distribution host 300 distributes firmware to the image forming apparatus 106 after the distribution host 300 distributes firmware to the image forming apparatus 100. Further, the image forming apparatuses 100 and 106 are the same products in the example.

Referring to FIG. 5, the processes are performed downwards from the top of the page. Further, the image forming apparatus 100 is referred to as a first image forming apparatus, and the image forming apparatus 106 as a second image forming apparatus.

The CPU 301 in the distribution host 300 executes a program for instructing distribution of the firmware and the printer driver. An operator of the distribution host 300 operates on a firmware distribution instruction screen 600 to be described below to instruct the distribution host 300 to distribute the firmware.

In step S501, the distribution host 300 then requests the image forming apparatus 100 to notify of the access client list 800 in response to, for example, an inquiry from the image forming apparatus 100 about whether there is an instruction to distribute the firmware.

In step S502, upon receiving the request, the image forming apparatus 100 determines whether there is the access client list 800 managed in the HDD 219. If there is the access client list 800 managed in the HDD 219, the image forming apparatus 100 notifies the distribution host 300 of the access client list 800. On the other hand, if there is no access client list 800, the image forming apparatus 100 notifies the distribution host 300 that there is no access client list 800.

In step S503, the distribution host 300 receiving the notification of the access client list 800 in step S502 stores the access client list 800 in the HDD 308 associated with the device ID of the image forming apparatus 100. The distribution host 300 then performs a process for selecting a distribution printer driver and selects a printer driver to be distributed to the image forming apparatus 100. The process for selecting the distribution printer driver will be described in detail below.

In step S504, the distribution host 300 distributes the selected printer driver to the image forming apparatus 100. At approximately the same time, the distribution host 300 changes driver version information in the access client list 800 stored in the HDD 308 to the version of the selected printer driver.

In step S505, the distribution host 300 distributes to the image forming apparatus 100 the firmware previously instructed by the operator of the distribution host 300. If the distribution host 300 received a notification that there is no access client list 800 in step S502, the distribution host 300 does not perform the process of step S504 and distributes the firmware in step S505.

In step S506, the image forming apparatus 100 (the first image forming apparatus) which received the printer driver in step S504 performs a process for selecting a printer driver distribution destination client PC, and selects the client PC 105 to be the printer driver distribution destination. The process for selecting the printer driver distribution destination client PC will be described in detail below.

In step S507, the image forming apparatus 100 distributes the printer driver to the printer setting monitoring program running on the client PC 105 selected in step S506.

The image forming apparatus 100 then updates the firmware in the image forming apparatus 100 using the firmware received in step S505.

In step S509, the printer setting monitoring program running on the client PC 105 which received the printer driver distribution in step S509 installs the received printer driver in the client PC 105. Further, the client PC 105 updates the printer driver settings for the image forming apparatus 100 in the client PC 105 and rewrites the type of printer driver used by the client PC 105.

The operator of the distribution host 300 then operates on the firmware distribution instruction screen 600 and instructs the distribution host 300 to distribute the firmware.

In step S510, the distribution host 300 requests the image forming apparatus 106 to notify of the access client list 800 in response to, for example, an inquiry from the image forming apparatus 106 about whether there is an instruction to distribute the firmware.

In step S511, upon receiving the request, the image forming apparatus 106 determines whether the access client list 800 is managed in the HDD 219. If the access client list 800 is managed in the HDD 219, the image forming apparatus 106 notifies the distribution host 300 of the access client list 800. On the other hand, if there is no access client list 800, the image forming apparatus 106 notifies the distribution host 300 that there is no access client list 800.

In step S512, the distribution host 300 receiving the notification of the access client list 800 in step S511 stores the access client list 800 in the HDD 308 associated with the device ID of the image forming apparatus 106. The distribution host 300 then performs a process for selecting a distribution printer driver and selects a printer driver to be distributed to the image forming apparatus 106. In the example of the sequence illustrated in FIG. 5, the distribution host 300 has already distributed the printer driver to the client PC 105 in step S504 and step S507. Therefore, in step S512, the distribution host 300 determines that it is only necessary to change the printer driver settings of the client PC 105. In step S513, the distribution host 300 then transmits an instruction to change a printer driver setting to the image forming apparatus 106. A content of the change instruction is, for example, the hardware ID of the client PC 105 and a type of printer driver used in the client PC 105.

In step S514, the distribution host 300 distributes the firmware previously instructed by the operator of the distribution host 300 to the image forming apparatus 106. If the distribution host 300 received a notification that there is no access client list 800 in step S511, the distribution host 300 does not perform the process of step S513 and distributes the firmware in step S514.

In step S515, the image forming apparatus 106 (the second image forming apparatus) which received the firmware in step S514 performs a process for selecting a printer driver setting change destination client PC, and selects the client PC 105 whose printer setting is to be changed.

In step S516, the image forming apparatus 106 then transmits the instruction to change a printer driver setting to the printer setting monitoring program running on the client PC 105 selected in step S515, according to the printer driver setting change instruction received in step S513. Further, the image forming apparatus 106 updates the firmware in the image forming apparatus 106 using the firmware received in step S514.

In step S517, the printer setting monitoring program running on the client PC 105 which received the printer driver setting change instruction in step S516 updates the printer driver setting in the image forming apparatus 106. For example, the client PC 105 rewrites the type of printer driver to be used in the image forming apparatus 106.

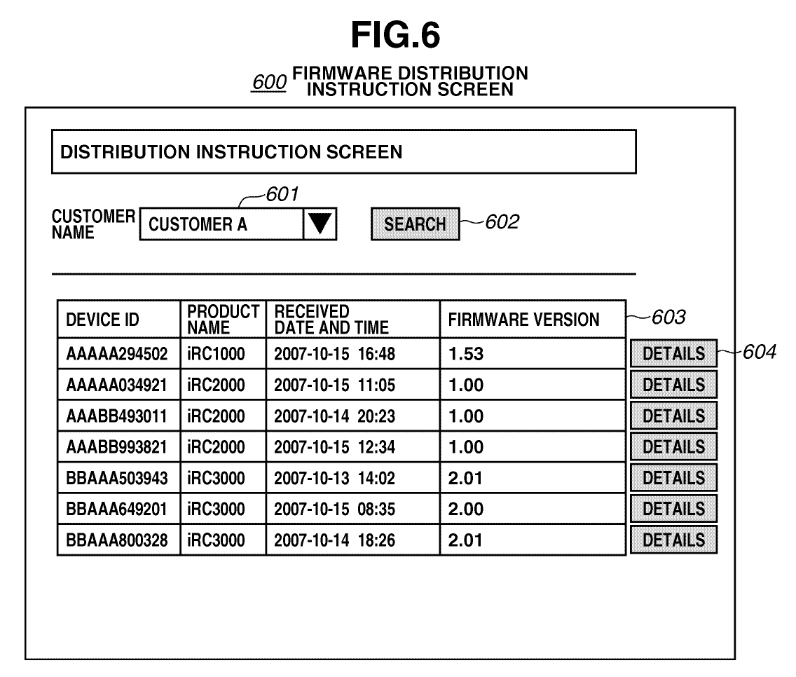

FIG. 6 illustrates an example of the firmware distribution instruction screen 600 displayed on the display device 309 of the distribution host 300.

The operator of the distribution host 300 can operate on the firmware distribution instruction screen 600 and instruct the distribution host 300 to distribute firmware to the desired image forming apparatus.

Referring to FIG. 6, the operator operates on a pull-down menu 601 and selects a name of a customer using (or managing) the image forming apparatus 100 or 106 to which the distribution host 300 distributes the firmware. The operator then presses a search button 602, and a search result list 603 is displayed on the lower portion of the firmware distribution instruction screen 600. The search result list 603 includes device ID, product name, and firmware version of the image forming apparatus managed in the distribution host 300 associated with the customer name. The operator previously registers the customer name associated with the image forming apparatus in the distribution host 300.

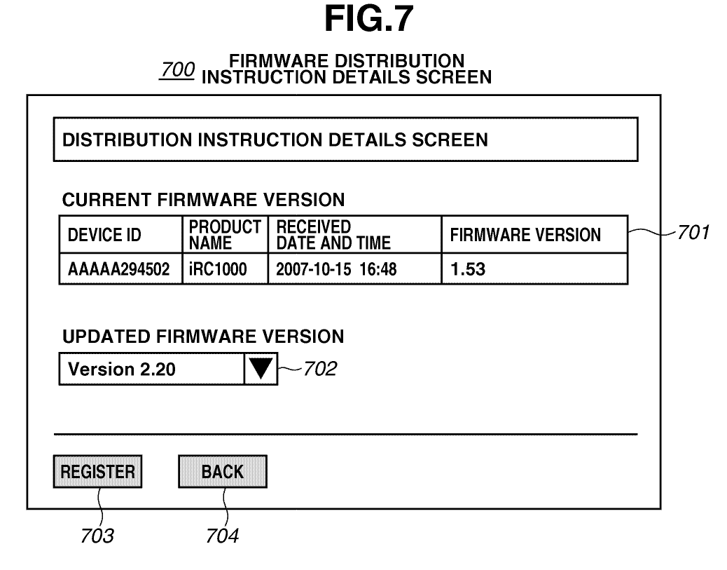

The operator then selects the image forming apparatus 100 or the image forming apparatus 106 to which the distribution host 300 distributes the firmware from the search result list 603, and presses a details button 604. A firmware distribution instruction details screen 700 illustrated in FIG. 7 is then displayed on the display device 309 of the distribution host 300.

FIG. 7 illustrates an example of the firmware distribution instruction details screen 700 displayed on the display device 309 of the distribution host 300.

Referring to FIG. 7, current information 701 of the image forming apparatus selected on the firmware distribution instruction screen 600 is displayed in the upper portion of the firmware distribution instruction details screen 700. The current information 701 of the image forming apparatus includes device ID, product name, and firmware version of the image forming apparatus. The image forming apparatus 100 or 106 regularly notifies the distribution host 300 of the firmware version displayed as the current information 701.

The operator operates on a pull-down menu 702 in an update firmware version box and selects a version of the firmware to be distributed. The operator then presses a register button 703, and the distribution host 300 confirms receipt of the firmware distribution instruction. The distribution host 300 thus stores the content of the instruction in the HDD 308 and closes the firmware distribution instruction details screen 700. If the operator presses a back button 704, the distribution host 300 closes the firmware distribution instruction details screen 700 without confirming receipt of the firmware distribution instruction.

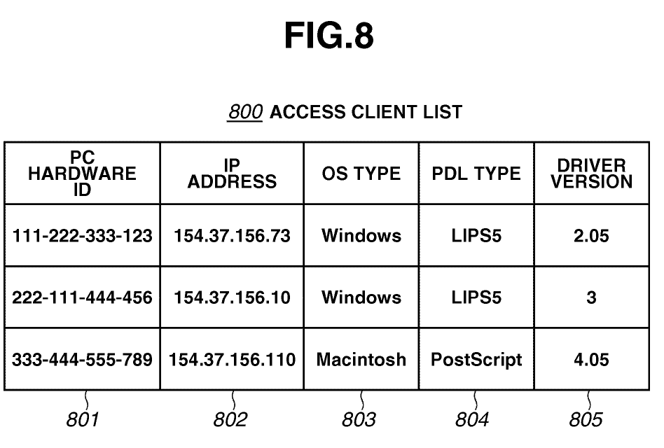

FIG. 8 is a schematic diagram of an example of a content of the access client list 800 managed inside the image forming apparatuses 100 and 106.

Referring to FIG. 8, the image forming apparatuses 100 and 106 generate the access client list 800 according to the printer settings received from the client PC 105 in step S402 illustrated in FIG. 4. The access client list 800 includes PC hardware ID 801, IP address 802, OS type 803, PDL type 804, and driver version 805. The PC hardware ID 801 is a hardware ID for uniquely identifying the client PC 105. The IP address 802 is an address for identifying the location of the client PC 105. The OS type 803 is a type of OS installed in the client PC 105. The PDL type 804 is a type of PDL of the printer driver used in the client PC 105. The driver version 805 is a version of the printer driver used in the client PC 105.

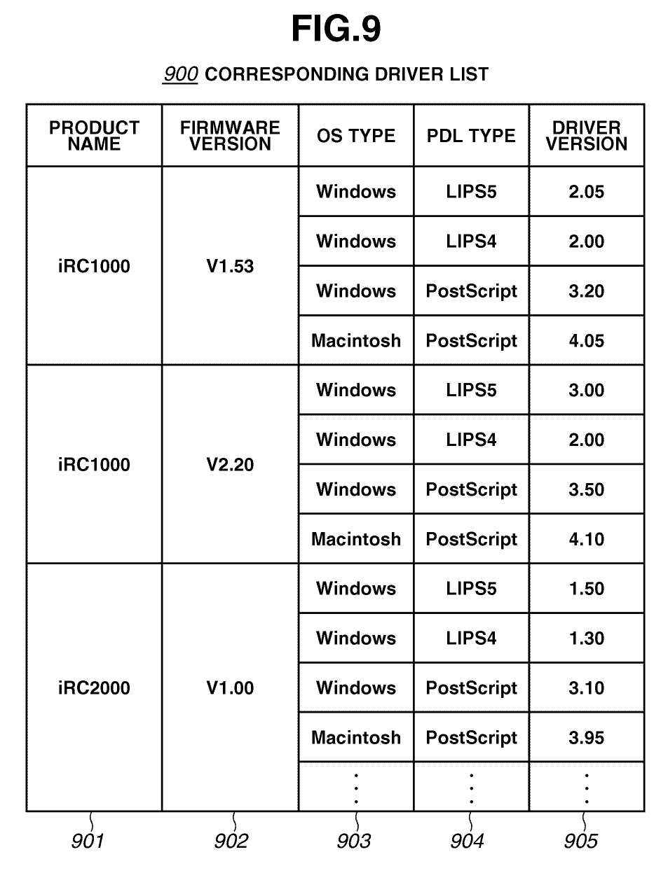

FIG. 9 is a schematic diagram of an example of a content of the corresponding driver list 900 managed inside the distribution host 300.

Firmware can be associated with printer drivers using the corresponding driver list 900. The corresponding driver list 900 includes product name 901, firmware version 902, OS type 903, PDL type 904, and driver version 905.

The product name 901 is a product name of the image forming apparatus to which the firmware is distributed. The firmware version 902 is the version of the firmware to be distributed. The OS type 903 is a type of OS in the client PC 105 which is to execute the printer driver. The PDL type 904 is the type of PDL of the printer driver. The driver version 905 is the version of the printer driver.

In the example illustrated in FIG. 9, a printer driver that corresponds to the firmware version “V1.53” for a product name, “iRC1000”, is as described below. If the client PC 105 uses a Windows® OS, and the PDL to be used is “LIPS5”, the corresponding printer driver is version “2.05”. The firmware and the printer drivers to be distributed, and information for associating the firmware with the printer drivers indicated in the corresponding driver list 900 are previously registered in the distribution host 300 by the operator.

As described above, according to the present exemplary embodiment, the corresponding driver list 900 is generated according to the operator instruction, and an example of a storing unit is realized by storing the corresponding driver list 900 in the HDD 308 of the distribution host 300.

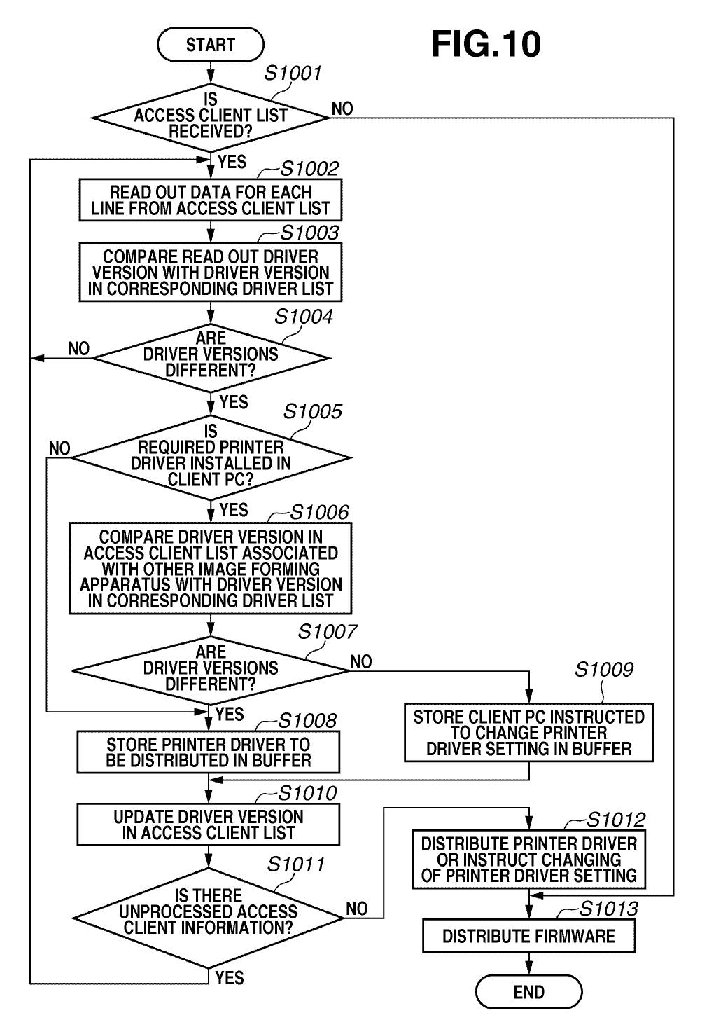

FIG. 10 is a flowchart illustrating an example of a process for selecting the distribution printer driver (corresponding to step S503 to step S505, and step S512 to step S514 illustrated in FIG. 5) performed by the distribution host 300. An example of a method of selecting a printer driver to be distributed will be described in detail below with reference to FIG. 10. In the example, the hardware ID of the client PC 105 is “111-222-333-123”, and the product name of the image forming apparatuses 100 and 106 is “iRC1000”. Further, the version of the firmware that the operator instructs the distribution host 300 to distribute is “V2.20”.

An example of the process for selecting the distribution printer driver (corresponding to step S502 to step S505 illustrated in FIG. 5) when the distribution host 300 receives a notification of the access client list 800 from the image forming apparatus 100 will be described below.

In step S1001, the distribution host 300 determines whether the access client list 800 is received from the image forming apparatus 100. If the access client list 800 is not received from the image forming apparatus 100 (NO in step S1001), the distribution host 300 determines that it is not necessary to distribute a printer driver, and the process proceeds to step S1013. In step S1013, the distribution host 300 only distributes the firmware to the image forming apparatus 100.

On the other hand, if the access client list 800 is received from the image forming apparatus 100 (YES in step S1001), the distribution host 300 stores the access client list 800 in the HDD 308 associated with the device ID of the image forming apparatus 100 which transmitted the access client list 800. In step S1002, the distribution host 300 reads out one line of data from the access client list 800.

As described above, according to the present exemplary embodiment, an example of an acquisition unit is realized by performing the process of step S1001.

In step S1003, the distribution host 300 compares the driver version 805 included in the data read out in step S1002 with the driver version 905 indicated in the corresponding driver list 900. In step S1004, the distribution host 300 determines whether the driver versions 805 and 905 are different and determines whether it is necessary to distribute the printer driver.

If the driver versions 805 and 905 are the same (NO in step S1004), the distribution host 300 determines that it is not necessary to distribute the printer driver, and the process returns to step S1002. On the other hand, if the driver versions 805 and 905 are different (YES in step S1004), the process proceeds to step S1005.

Referring to FIG. 8, the OS type 803 of the client PC 105 (111-222-333-123) is Windows® OS, the PDL type 804 of the printer driver is “LIPS5”, and the driver version 805 is “2.05”. On the other hand, the driver version 905 that corresponds to an update of the firmware version “V2.20” is “3.00”, according to the corresponding driver list 900 illustrated in FIG. 9. Therefore, the process proceeds to step S1005.

As described above, according to the present exemplary embodiment, an example of a determination unit is realized by performing the process of step S1004.

In step S1005, the distribution host 300 determines whether the required printer driver is already installed in the client PC 105. In the present exemplary embodiment, the distribution host 300 searches information about the data read out in step S1002 (the PC hardware ID 801) from the access client list 800 received from an image forming apparatus other than the image forming apparatus 100 and stored in the HDD 308. More specifically, the distribution host 300 searches for information about the hardware ID “111-222-333-123”.

If the information about the PC hardware ID 801 (“111-222-333-123”) read out in step S1002 exists, the distribution host 300 determines that the printer driver required in the client PC 105 is installed (YES in step S1005). The process then proceeds to step S1006. On the other hand, if there is no information about the PC hardware ID (“111-222-333-123”) read out in step S1002, the distribution host 300 determines that the printer driver required in the client PC 105 is not installed (NO in step S1005). The process then proceeds to step S1008.

At this stage, a printer driver for Windows®, whose PDL is LIPS 5, and which is version 3.0, that corresponds to the updated firmware, is not distributed to the client PC 105. As a result, the distribution host 300 determines the printer driver required in the client PC 105 is not installed (it is necessary to distribute the printer driver), and the process proceeds to step S1008.

As described above, according to the present exemplary embodiment, an example of a determination unit is realized by performing the process of step S1005.

In step S1005, if the information about the PC hardware ID 801 read out in step S1002 is retrieved (YES in step S1005), the distribution host 300 performs the processes described below.

In step S1006, the distribution host 300 compares the version of the printer driver that corresponds to the retrieved information with the driver version 905 (3.00) read out from the corresponding driver list 900 in step S1003.

In step S1007, the distribution host 300 then determines whether the driver versions compared in step S1006 are different. If the driver versions are different (YES in step S1007), a printer driver other than the driver version 905 (3.00) read out from the corresponding driver list 900 in step S1003 is already installed in the client PC 105. In such a case, the distribution host 300 also determines that it is necessary to distribute the printer driver, and the process proceeds to step S1008. A case where the printer driver versions are the same (NO in step S1007) and the process proceeds to step S1009 will be described below.

As described above, according to the present exemplary embodiment, an example of a determination unit is realized by performing the process of step S1007.

In step S1008, the distribution host 300 stores the printer driver to be distributed in a work buffer in the RAM 303. More specifically, the distribution host 300 stores a printer driver for Windows®, whose PDL is LIPS 5, and which is version 3.00, as the printer driver to be distributed.

In step S1010. The distribution host 300 then updates the access client list 800 stored in the HDD 308 associated with the device ID of the image forming apparatus 100. More specifically, the distribution host 300 rewrites the driver version 805 to “3.00” in the access client list 800 stored in the HDD 308 associated with the device ID of the image forming apparatus 100.

In step S1011, the distribution host 300 determines whether information about a different client PC (PC hardware ID 801) which has not been processed is included in the access client list 800 received in step S1001. If the distribution host 300 determines that information about a different client PC (PC hardware ID 801) which has not been processed is included in the access client list 800 received in step S1001 (YES in step S1011), the process returns to step S1002, and the above-described process is repeated.

On the other hand, if the distribution host 300 has finished processing all information in the access client list received in step S1001 (NO in step S1011), the process proceeds to step S1012. In step S1012, the distribution host 300 distributes a printer driver to the image forming apparatus 100 based on the content stored in the work buffer in step S1008. More specifically, the distribution host 300 distributes the printer driver for Windows®, whose PDL is LIPS 5, and which is version 3.00, to the image forming apparatus 100.

As described above, according to the present exemplary embodiment, an example of a first distribution unit is realized by performing the process of step S1012.

In step S1013, the distribution host 300 distributes the firmware of the version as instructed by the operator to the image forming apparatus 100. More specifically, the distribution host 300 distributes the firmware version “V2.20” to the image forming apparatus 100.

As described above, according to the present exemplary embodiment, an example of a second distribution unit is realized by performing the process of step S1013.

An example of the distribution printer driver selection process (corresponding to step S512 to step S514 illustrated in FIG. 5) performed when the distribution host 300 receives a notification of the access client list 800 from the image forming apparatus 106 will be described below.

In step S1001, the distribution host 300 determines whether the access client list 800 is received from the image forming apparatus 106. If the access client list 800 is not received from the image forming apparatus 106 (NO in step S1001), the distribution host 300 determines that it is not necessary to distribute a printer driver, and the process proceeds to step S1013. In step S1013, the distribution host 300 distributes only the firmware to the image forming apparatus 106.

On the other hand, if the access client list 800 is received from the image forming apparatus 106 (YES in step S1001), the distribution host 300 stores the access client list 800 in the HDD 308 associated with the device ID of the image forming apparatus 106 which transmitted the access client list 800. In step S1002, the distribution host 300 reads out each line of data one by one from the access client list 800.

In step S1003, the distribution host 300 compares the driver version 805 in the data read out in step S1002 with the driver version 905 in the corresponding driver list 900. In step S1004, the distribution host 300 determines whether the driver versions 805 and 905 are different and determines whether it is necessary to distribute the printer driver.

If the distribution host 300 determines that the driver versions 805 and 905 are the same (NO in step S1004), the distribution host 300 determines that it is not necessary to distribute the printer driver, and the process returns to step S1002. On the other hand, if the distribution host 300 determines that the driver versions 805 and 905 are different (YES in step S1004), the process proceeds to step S1005.

Referring to FIG. 8, the OS type 803 of the client PC 105 (111-222-333-123) is Windows® OS, the PDL type 804 of the printer driver is “LIPS5”, and the driver version 805 remains “2.05”. On the other hand, the driver version 905 that corresponds to the update firmware version “V2.20” is “3.00”, according to the corresponding driver list 900 illustrated in FIG. 9. Therefore, the process proceeds to step S1005.

In step S1005, the distribution host 300 determines whether the required printer driver is already installed in the client PC 105. In the present exemplary embodiment, the distribution host 300 searches for information about the hardware ID “111-222-333-123” in the access client list 800 received from an image forming apparatus other than the image forming apparatus 106 and stored in the HDD 308. As described above, since the distribution host 300 has already received the access client list 800 from the image forming apparatus 100, the information about the PC hardware ID “111-222-333-123” is retrieved from the received access client list 800 (YES in step S1005). The process then proceeds to step S1006.

In step S1006, the distribution host 300 compares the version of the printer driver corresponding to the retrieved information with the driver version 905 read out from the corresponding driver list 900 in step S1003 (i.e., 3.00). In step S1007, the distribution host 300 determines whether the driver versions compared in step S1006 are different. As described above, the corresponding driver version 805 is rewritten as “3.00” in the access client list 800. Therefore, the distribution host 300 determines that the printer driver for Windows®, whose PDL is LIPS 5, and which is version 3.00, is already distributed to the client PC 105. The process then proceeds to step S1009.

As described above, according to the present exemplary embodiment, an example of a second determination unit is realized by performing the process of step S1007.

In step S1009, the distribution host 300 stores an instruction for printer driver setting change to the client PC 105 in the work buffer of the RAM 303. More specifically, the distribution host 300 stores an instruction to change the printer driver to be used for the image forming apparatus 106 to the printer driver for Windows®, whose PDL is LIPS 5, and which is version 3.00.

In step S1010, The distribution host 300 updates the access client list 800 stored in the HDD 308 associated with the device ID of the image forming apparatus 106. The distribution host 300 thus rewrites the driver version 805 to “3.00” in the access client list 800 stored in the HDD 308 associated with the device ID of the image forming apparatus 106.

In step S1011, the distribution host 300 determines whether information about a different client PC (PC hardware ID 801) which has not been processed is included in the access client list 800 received in step S1001. If the distribution host 300 determines that information about a different client PC (PC hardware ID 801) which has not been processed is included in the access client list 800 received in step S1001 (YES in step S1011), the process returns to step S1002, and the above-described process is repeated.

On the other hand, if the distribution host 300 has finished processing all information in the access client list received in step S1001 (NO in step S1011), the process proceeds to step S1012. In step S1012, the distribution host 300 instructs the image forming apparatus 106 to change the printer driver setting based on the content stored in a work buffer in step S1008.

As described above, according to the present exemplary embodiment, an example of a third distribution unit is realized by performing the process of step S1012.

In step S1013, the distribution host 300 distributes the firmware of the version as instructed by the operator to the image forming apparatus 100. More specifically, the distribution host 300 distributes the firmware version “V2.20” to the image forming apparatus 100.

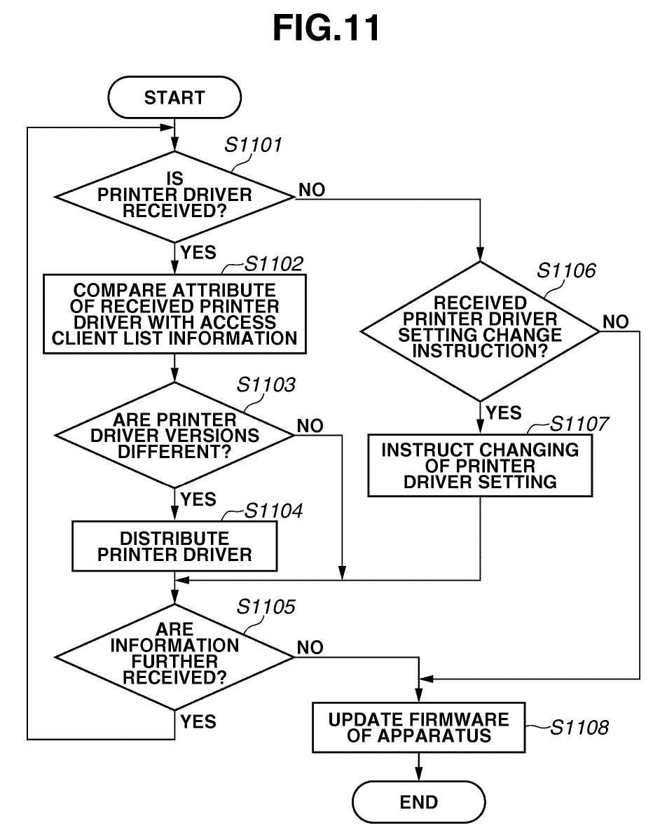

FIG. 11 is a flowchart illustrating an example of a process for selecting the printer driver distribution destination client PC (corresponding to step S506, step S507, step S515, and step S516 illustrated in FIG. 5) performed by the image forming apparatuses 100 and 106. An example of a method of selecting a client PC to which the printer driver is distributed will be described in detail below with reference to FIG. 11.

In step S1101, the image forming apparatus 100 or 106 determines whether the printer driver is received from the distribution host 300. If the printer driver is not received from the distribution host 300 (NO in step S1101), the process proceeds to step S1106. On the other hand, if the printer driver is received from the distribution host 300 (Yes in step S1101), the process proceeds to step S1102.

In step S1102, the image forming apparatus 100 or 106 compares the information about the received printer driver with the information in the access client list 800 managed in the HDD 219. Information that is compared here is, for example, the OS type of the client PC 105, the PDL type of the printer driver, and the version of the printer driver (driver version).

In step S1103, the image forming apparatus 100 or 106 determines whether the version of the received printer driver and the version in the access client list 800 managed in the HDD 219 are different. For example, if the OS types of the client PC 105 match and the PDL types of the printer drivers match, and the versions of the printer drivers are different (YES in step S1103), the process proceeds to step S1104. Otherwise (NO in step S1103), the process proceeds to step S1105.

In step S1104, the image forming apparatus 100 or 106 distributes the printer driver received in step S1012 illustrated in FIG. 10 to the printer setting monitoring program running on the client PC 105.

In step S1105, the image forming apparatus 100 or 106 determines whether information is further received from the distribution host 300. If information is further received (YES in step S1105), the process returns to step S1101 and the above-described process is repeated. On the other hand, if information is not further received (NO in step S1105), the process proceeds to step S1108.

Returning to step S1101, if the image forming apparatus 100 or 106 determines that the printer driver is not received from the transmission host 300 (NO in step S1101), the process proceeds to step S1106. In step S1106, the image forming apparatus 100 or 106 determines whether an instruction to change printer driver setting is received. If the printer driver setting change instruction is not received (NO in step S1106), the process proceeds to step S1108.

On the other hand, if the instruction to change printer driver setting is received (YES in step S1106), the process proceeds to step S1107. In step S1107, the image forming apparatus 100 or 106 transmits the printer driver setting change instruction to the printer setting monitoring program running on the client PC 105. The process then proceeds to step S1105, and the image forming apparatus 100 or 106 determines whether information is further received. If information is further received (YES in step S1105), the process returns to step S1101, and the above-described process is repeated.

If the image forming apparatus 100 or 106 has processed all printer driver setting change instructions received from the distribution host 300 (NO in step S1105), the process proceeds to step S1108. In step S1108, the image forming apparatus 100 or 106 updates the firmware in the image forming apparatus 100 or 106 using the firmware received from the distribution host 300.

As described above, according to the present exemplary embodiment, the image forming apparatus 100 or 106 acquires printer settings in each client PC which controls the image forming apparatus from the client PC, and registers the printer settings in the access client list 800. Further, the distribution host 300 previously registers the corresponding driver list 900 based on the operator instruction. The corresponding driver list 900 associates a version of the firmware to be distributed to the image forming apparatus 100 or 106 with the version of the printer driver that corresponds to the firmware.

When the operator instructs to distribute a version of the firmware to the client PC 105, the distribution host 300 acquires the access client list 800 from the image forming apparatus 100 or 106. The distribution host 300 then compares the acquired access client list 800 with the corresponding driver list 900 and determines whether there is a printer driver that needs to be distributed as a result of distribution of the firmware instructed by the user.

If there is a printer driver that needs to be distributed, the distribution host 300 selects the printer driver required to be distributed to the image forming apparatus 100 or 106 from the corresponding driver list 900. The distribution host 300 then distributes the selected printer driver and the firmware which the user instructs to distribute to the image forming apparatus 100 or 106. The image forming apparatus 100 or 106 distributes the received printer driver to the client PC 105 and updates the current firmware using the received firmware.

Therefore, the distribution host 300 automatically identifies a client PC affected by updating of the firmware in the image forming apparatus, along with the updating, and updates the printer driver in the identified client PC. Further, the distribution host 300 determines whether there is a printer driver that needs to be distributed as a result of distribution of the firmware instructed by the operator. If there is such a printer driver, the printer driver is distributed, so that the distribution of the printer driver to the client PC can be minimized. As a result, processing load such as network traffic caused by the distribution can be reduced.

Further, in the present exemplary embodiment, when the distribution host 300 acquires the access client list 800, the distribution host 300 performs the process described below. The distribution host 300 searches for the PC hardware ID 801 of the client PC which is a processing target in the acquired access client list 800, from the access client list 800 already acquired from an image forming apparatus other than the image forming apparatus that has transmitted the access client list 800.

If the PC hardware ID 801 of the client PC to be processed exists, the distribution host 300 acquires the driver version 805 corresponding to the PC hardware ID 801 of the client PC to be processed, from each of the access client list 800 being processed and the access client list 800 already acquired from another image forming apparatus. If the acquired driver version 805 is different, the printer driver is distributed to the image forming apparatus as described above. If the acquired driver version 805 is the same, the image forming apparatus is instructed to change the printer driver setting. As a result, the distribution of the printer driver to the client PC can be minimized, and processing load such as network traffic caused by distribution can be reduced.

Each of the units configuring the distribution apparatus and each step in the distribution method according to the exemplary embodiment of the present invention can also be achieved by executing a software (program code) stored in a RAM or a ROM in a computer. The software (program code) and the computer-readable storage medium may thus constitute the present invention.

The present invention can be embodied as a system, apparatus, method, program or a storage medium. More specifically, the present invention can be applied to a system including a plurality of devices or to an apparatus of a single device.

The present invention can also be achieved by providing software (program code) for implementing functions of the above-described exemplary embodiments (sequences illustrated in FIGS. 4 and 5, and programs that correspond to flowcharts illustrated in FIGS. 10 and 11 according to the exemplary embodiment) directly or remotely to a system or an apparatus. The software (program code) can be read and executed by a computer of the system or the apparatus.

The software (program code) itself, installed in the computer for implementing functional processes of the present invention on the computer, realizes the present invention. More specifically, the software (program code) realizing the functional processes of the present invention may thus constitute the present invention.

Software to implement the above-mentioned exemplary embodiments can take any form readable by computer, for example, an object code, a program executed by an interpreter, or script data to be supplied to an operating system (OS).

The storage medium can be, for example, a floppy disk, a hard disk, an optical disk, a magneto-optical (MO) disk, a compact disc ROM (CD-ROM), a CD-recordable (CD-R), a CD-rewritable (CD-RW), a magnetic tape, a nonvolatile memory card, a ROM, or a digital versatile disc (DVD, DVD-ROM, and DVD-R).

Such software (program code) can also be supplied by accessing a web page on the Internet through the browser of a client computer. The software (program code) itself or a compressed file including an auto-install function can be downloaded from the web page onto a storage medium such as a hard disk.

Furthermore, the above-described exemplary embodiments can be realized by executing software (program code) read by a CPU. An operating system (OS) or the like working on a computer can also perform a part or the whole of processes according to instructions of the software (program code) and realize functions of the above-described exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-100678 filed Apr. 8, 2008 which is hereby incorporated by reference herein in its entirety.

What is claimed is:

1. A distribution apparatus comprising:
a storing unit configured to store in a storage medium information about firmware used in an image forming apparatus associated with information about a printer driver that corresponds to the firmware;
an acquisition unit configured to acquire information about a printer driver in a terminal apparatus;
a first distribution unit configured to distribute a printer driver that corresponds to firmware which a user instructs to distribute, based on information acquired by the acquisition unit and information stored by the storing unit; and
a second distribution unit configured to distribute the firmware which the user instructs to distribute.

2. The distribution apparatus according to claim 1, further comprising a determination unit configured to determine whether there is a printer driver that needs to be distributed when the firmware which the user instructs to distribute is distributed, based on information acquired by the acquisition unit and information stored by the storing unit,
wherein the first distribution unit reads out information about a printer driver associated with information about the firmware which the user instructs to distribute and distributes a printer driver that corresponds to the information which is read out, if the determination unit determines whether there is a printer driver that needs to be distributed when the firmware which the user instructs to distribute is distributed.

3. The distribution apparatus according to claim 2, wherein the determination unit determines whether there is a printer driver that needs to be distributed when the firmware which the user instructs to distribute is distributed, if the information about a printer driver acquired by the acquisition unit does not match the information about a printer driver stored in the storage medium associated with the firmware which the user instructs to distribute.

4. The distribution apparatus according to claim 2, wherein the determination unit determines whether there is a printer driver that needs to be distributed when the firmware which the user instructs to distribute is distributed, if a terminal apparatus according to the information acquired by the acquisition unit does not include a printer driver that corresponds to the information about a printer driver stored in the storage medium associated with information about the firmware which the user instructs to distribute.

5. The distribution apparatus according to claim 4, wherein the determination unit determines whether there is a printer driver that needs to be distributed when the firmware which the user instructs to distribute is distributed, if a terminal apparatus according to the information acquired by the acquisition unit includes a printer driver of a different version as a printer driver that corresponds to the information about a printer driver stored in the storage medium associated with information about the firmware which the user instructs to distribute.

6. A distribution apparatus according to claim 1, further comprising:
a second determination unit configured to determine whether there is a terminal apparatus that needs to change printer driver settings when the firmware which the user instructs to distribute is distributed, based on the information acquired by the acquisition unit and the information stored by the storing unit; and
a third distribution unit configured to distribute information about instruction to change printer driver settings, if the second determination unit determines whether there is a terminal apparatus that needs to change printer driver settings when the firmware which the user instructs to be distribute is distributed.

7. A distribution apparatus according to claim 6, wherein the acquisition unit acquires information including information about a printer driver in a terminal apparatus from an image forming apparatus controlled by the printer driver, and
wherein the second determination unit determines whether there is a terminal apparatus that needs to change printer driver settings when the firmware which the user instructs to distribute is distributed, if a terminal apparatus according to the information acquired by the acquisition unit includes a printer driver of a same version as a printer driver that corresponds to the information about a printer driver stored in the storage medium associated with information about the firmware which the user instructs to distribute, and the printer driver corresponds to an image forming apparatus that is different from an image forming apparatus which is a transmission source of the information acquired by the acquisition unit.

8. A distribution method comprising:
storing in a storage medium information about firmware used in an image forming apparatus associated with information about a printer driver that corresponds to the firmware;
acquiring information about a printer driver in a terminal apparatus;
distributing a printer driver that corresponds to firmware which a user instructs to distribute, based on the acquired information and the stored information; and
distributing the firmware which the user instructs to distribute.

9. A computer-readable storage medium storing a control program which causes a computer to execute a distribution method comprising:
storing in a storage medium information about firmware used in an image forming apparatus associated with information about a printer driver that corresponds to the firmware;
acquiring information about a printer driver in a terminal apparatus;
distributing a printer driver that corresponds to firmware which a user instructs to distribute, based on the acquired information and the stored information; and distributing the firmware which the user instructs to distribute.
